(19) United States
(12) Patent Application Publication
(10) Pub. No.: US 2023/0262037 A1
(43) Pub. Date: Aug. 17, 2023

(54) TECHNIQUES FOR AUTHENTICATING USING UNIQUELY ASSIGNED WEBPAGES

(71) Applicant: Concept Source, Inc., Plainview, NY (US)

(72) Inventor: Charles RAFFAY, Jensen Beach, FL (US)

(73) Assignee: Concept Source, Inc., Plainview, NY (US)

(21) Appl. No.: 17/651,129

(22) Filed: Feb. 15, 2022

(51) Int. Cl. H04L 9/40

(52) U.S. Cl. CPC H04L 63/08; H04L 2463/082

(57) ABSTRACT

Techniques for authenticating via uniquely assigned webpages. A method includes encoding an authentication webpage into code including a security token that is uniquely assigned to a user. The code of the authentication webpage configures a system to display the authentication webpage and to provide the security token to a service requiring authentication by the user when the code is executed by the system. A database including the code of the authentication webpage is created. The code of the authentication webpage is provided from the database to a device when the device navigates to a web address of the authentication webpage.

### TECHNICAL FIELD

The present disclosure relates generally to authenticating users of computing devices, and more specifically to using uniquely assigned webpages in order to demonstrate a factor of authentication.

### BACKGROUND

In the computing context, authentication typically refers to a process for proving the identity of a user of a computer system. Authentication as a process involves verifying an identity asserted by such a computer system. As more and more aspects of daily life become computerized, ensuring that the identities behind computer systems becomes increasingly important. However, modern computing solutions must balance security of authentication with convenience to users, since overly burdensome authentication processes may discourage users, causing them to turn off security features or stop using certain services.

More particularly, both individual users and large organizations are storing increasingly sensitive data on their computer systems such that any unauthorized access could be catastrophic. For the individual, unauthorized access can effectively result in identity theft or can allow malicious entities to drain their personal funds. For the organization, leaked data can result in corporate liability for leaked user data or other losses caused by leaking confidential information such as trade secrets or business plans.

The means by which an identity of a user can demonstrate their identity generally fall into one of three categories: something the user knows (also referred to as knowledge factors), something the user has (also referred to as ownership factors), and something the user is or does (also referred to as inherence factors). Example knowledge factors include passwords, pass phrases, personal identification numbers (PINs), security questions, and the like. Example ownership factors include identification cards, implanted devices, computing devices like cell phones, hardware tokens, software tokens, and the like. Example inherence factors include fingerprints, retinal patterns, DNA sequences, facial features, voice, and the like.

Each of these means can be used as a distinct factor of authentication as part of a larger, multi-factor authentication process. A multi-factor authentication process requires two or more factors of authentication. A classic example of multi-factor authentication is requiring a username and password (i.e., a knowledge factor) along with a passcode received via the user's cell phone (i.e., thereby demonstrating ownership of the cell phone as an ownership factor). Using a multi-factor authentication process provides additional assurance that the user's identity has been correctly verified.

For the reasons noted above, new techniques for providing factors for authenticating users' identities as well as new techniques for facilitating authentication processes are highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for authenticating via uniquely assigned webpages, comprising: encoding an authentication webpage into code, wherein the code of the authentication webpage at least configures a system to display the authentication webpage and to provide a security token to a service requiring authentication when the code is executed by the system, wherein the authentication webpage has a web address, wherein the security token is uniquely assigned to a user; creating a database including the code of the authentication webpage; and providing the code of the authentication webpage from the database to a device when the device navigates to the web address of the authentication webpage.

Certain embodiments disclosed herein also include a non-transitory computer readable medium having stored thereon causing a processing circuitry to execute a process, the process comprising: encoding an authentication webpage into code, wherein the code of the authentication webpage at least configures a system to display the authentication webpage and to provide a security token to a service requiring authentication when the code is executed by the system, wherein the authentication webpage has a web address, wherein the security token is uniquely assigned to a user; creating a database including the code of the authentication webpage; and providing the code of the authentication webpage from the database to a device when the device navigates to the web address of the authentication webpage.

Certain embodiments disclosed herein also include a system for encoding assets owned via tokens as webpages. The system comprises: a processing circuitry; and a memory, the memory containing instructions that, when executed by the processing circuitry, configure the system to: encode an authentication webpage into code, wherein the code of the authentication webpage at least configures a system to display the authentication webpage and to provide a security token to a service requiring authentication when the code is executed by the system, wherein the authentication webpage has a web address, wherein the security token is uniquely assigned to a user; create a database including the code of the authentication webpage; and provide the code of the authentication webpage from the database to a device when the device navigates to the web address of the authentication webpage.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a visual depiction of nodes in a database realized as a hypergraph illustrating an implementation where an authentication webpage acts as a wallet holding unique asset tokens.

FIG. 3 is a flowchart illustrating a method for authenticating users with uniquely assigned webpages according to an embodiment.

FIG. 4 is a flowchart illustrating a method for creating a database uniquely assigning webpages to users according to an embodiment.

FIG. 5 is a flowchart illustrating an example authentication by a user via a uniquely assigned webpage.

FIG. 6 is an authentication establisher according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include methods and systems for authenticating via uniquely assigned webpages. The disclosed embodiments provide a new means of authenticating and, more specifically, provide a new kind of authentication factor that can be recognized and utilized as part of an authentication process. The disclosed embodiments manipulate interactions with the Internet in order to provide security tokens that are uniquely assigned to respective users, thereby demonstrating a user's identity. Various disclosed embodiments further utilize properties of webpages and manipulate interactions with the Internet in order to facilitate user interactions during a multi-factor authentication process.

In accordance with various disclosed embodiments, a request to establish a user identity of a user via a uniquely assigned webpage is received. An authentication webpage is created and encoded. In some embodiments, the encoded webpage includes instructions that configure a device to display the authentication webpage and to provide a security token uniquely assigned to a user as a factor of authentication when the instructions are executed on the device of the user. The code of the authentication webpage is stored in a database. A web address of the authentication webpage may be secretly provided to the user such that the user can later access the authentication webpage in order to demonstrate the user's identity.

Once the database including the encoded authentication webpage is created, a request for the authentication webpage is received. Such a request may be realized in the form of navigation by the user to the web address of the authentication webpage via a user device, thereby causing the user device to send a request for the content of the authentication webpage to a server hosting the authentication webpage. Navigating to the authentication webpage may therefore demonstrate a factor of authentication on its own, i.e., because only an authorized user should have the web address used to navigate to the webpage.

The contents of the authentication webpage, including the instructions for providing the security token, are provided to the user device in response to the request for the authentication webpage. When the user requests a factor of authentication via the webpage (e.g., by interacting with an icon or other interactable component of the authentication webpage associated with such a request), the security token is provided to a service requiring authentication by the user. The security token may be included in a message sent to the user via another channel (e.g., email, text message, short message service, etc.) and provided to the service when the user interacts with a link or code embedded in the message, thereby providing the user with the mechanism by which to demonstrate an additional factor of authentication.

In some implementations, the disclosed embodiments also allow for authenticating using a wallet (e.g., a wallet computer program or a wallet computing device) associated with the authentication webpage, thereby allowing the wallet to effectively serve as a factor of authentication. More specifically, the wallet may be configured to access the authentication webpage. Possession of the wallet program or device may therefore allow the user to access the authentication webpage in order to demonstrate a factor of authentication without necessarily requiring the user to provide a password since only the user should be in possession of the wallet.

In other implementations, the wallet may be realized as a wallet webpage which is accessible to the user via a uniform resource locator (URL) or otherwise accessible at a web address. In various implementations, such a wallet webpage can be accessed without requiring a password because the URL itself is unique to the user (i.e., the URL is only provided to the user and shared only with entities authorized by the user).

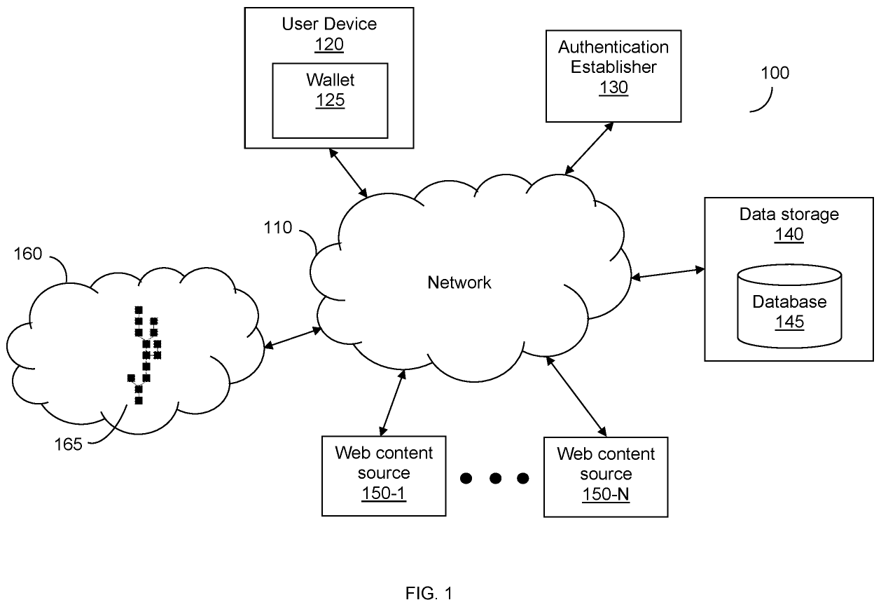

FIG. 1 shows an example network diagram 100 utilized to describe the various disclosed embodiments. In the example network diagram 100, a user device 120, an authentication establisher 130, a data storage 140, a plurality of web content sources 150-1 through 150-N (hereinafter referred to individually as a web content source 150 and collectively as web content sources 150, merely for simplicity purposes), and a blockchain network 160 communicate via a network 110.

The network 110 may be, but is not limited to, a wireless, cellular or wired network, a local area network (LAN), a wide area network (WAN), a metro area network (MAN), the Internet, the worldwide web (WWW), similar networks, and any combinations thereof.

The user device (UD) 120 may be, but is not limited to, a personal computer, a laptop, a tablet computer, a smartphone, a wearable computing device, or any other device capable of navigating to webpages and displaying web content. The user device is equipped with one or more input/output (I/O) devices (not depicted in FIG. 1) which can display or otherwise project web content associated with webpages or portions of webpages.

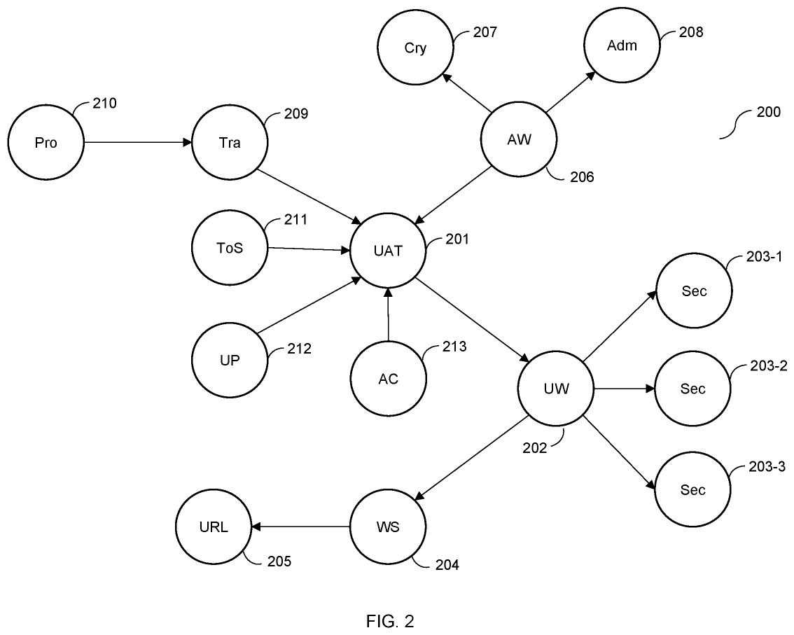

In some implementations, the user device 120 includes a wallet 125. In the implementation depicted in FIG. 1, the wallet 125 may be a program stored and executed on the user device 120. In other implementations, the wallet 125 may be a device (not depicted in FIG. 1) connected to the user device 120. In yet other embodiments, the wallet 125 may be stored on another system (not depicted in FIG. 1) such as a server of an NFT platform or another server owned by a provider of NFT services. As a non-limiting example, the wallet 125 may be realized as a node stored in a database (e.g., the database 145) which is connected to other nodes such as, but not limited to, nodes representing assets (e.g., tokens or cryptocurrency) owned via the wallet 125. In implementations using the wallet 125, the wallet 125 stores ownership data used to access webpage content of an authentication webpage represented in the database 145 (e.g., an authentication webpage represented by the wallet node 206, FIG. 2).

The authentication establisher 130 is configured to at least uniquely assign authentication webpages to users via security tokens and to encode the authentication webpages into code such that the code, when executed at a user device, configures the user device to cause the security tokens to be provided to services requiring authentication. To this end, the authentication establisher 130 may be configured to provide the code of the authentication webpage when a user device navigates to a web address of the authentication webpages. In various embodiments, the authentication establisher 130 is further configured to encode webpages and create databases (e.g., a database 145) including nodes and webpage code as described herein. The authentication establisher 130 may be further configured to provide the code of webpages to owners of certain nodes in the database 145 as described herein.

The data storage 140 stores a database 145 that is at least partially populated with data used by the authentication establisher 130 as described herein. Such data may include, but is not limited to, code of authentication webpages, nodes representing authentication webpages (e.g., the authentication webpage node 206, FIG. 2), other nodes, edges, combinations thereof, and the like. The database 145 stores nodes (not depicted in FIG. 1) connected to each other (e.g., via edges). The nodes at least include webpage nodes associated with respective webpages. In an embodiment, the database 145 may be realized as a graph (e.g., a hypergraph such as a multi-tenant temporal hypergraph). An example illustration of nodes in the database 145 realized as a graph is described further below with respect to FIG. 2.

The web content sources 150 store content of webpages such as, but not limited to, media content, computer code, and the like. Such content is encoded by the authentication establisher 130 as described herein and stored in the database 145 in order to enable providing the appropriate web content when such content is requested. The encoded webpage content includes portions of code such as, but not limited to, code for displaying a webpage, code for performing one or more authentication-related tasks (e.g., providing a security token, sending messages as part of additional factors of authentication, etc.), and the like. Such portions of code may include instructions in formats such as, but not limited to, cascading style sheets (CSS), Javascript, hypertext markup language (HTML), combinations thereof, and the like.

The blockchain network 160 includes multiple computing nodes (not shown), each computing node storing a copy of a blockchain 165. In various embodiments, the database 145 or a copy of the database 145 may be stored on the blockchain 165, thereby enabling the benefits of such blockchain use. To this end, in some embodiments, the authentication establisher 130 may be configured to upload transactions to the blockchain 165 as the database 145 is updated. The transactions uploaded to the blockchain 165 may include a full copy of the database 145 or one or more changes to the existing copy of the database 145.

It should be noted that the network diagram 100 is merely an example, and that other combinations of networked components may be equally utilized without departing from the scope of the disclosure. Further, it should be noted that all components illustrated in FIG. 1 are depicted as communicating via a single network 110 merely for simplicity, but that different networks or no networks may be used for different communications among the components without departing from the scope of the disclosure.

FIG. 2 is a non-limiting example visual depiction 200 of nodes in a database realized as a hypergraph. FIG. 2 illustrates a non-limiting example of nodes in a database through which the disclosed embodiments may be realized and, in particular, demonstrate how the disclosed embodiments can be applied to utilize a wallet as a factor of authentication via authentication webpages as described herein.

The example visual depiction 200 includes various nodes utilized to realize a non-limiting example implementation in which an authentication webpage represented by an authentication webpage (AW) node 206 is uniquely assigned to a user. In the example implementation shown in FIG. 2, the authentication webpage node 206 is connected to a unique asset token (UAT) node 201 representing a tokenized version of a unique asset (not shown) such that the authentication webpage node 206 acts as a wallet node containing data demonstrating ownership of the unique asset represented by the UAT 201.

The authentication webpage node 206 includes or is otherwise associated with a security token (not shown) that is uniquely assigned to the user and, consequently, is unique to the authentication webpage node 206. Consequently, the security token uniquely identifies the user. Additionally, by including the security token in the authentication webpage or otherwise associating the security token with the authentication webpage, the authentication webpage also becomes uniquely associated with the user such that the ability to access the authentication webpage (e.g., as demonstrated by entering a URL or otherwise navigating to the authentication webpage via a user device) demonstrates the user's ownership of the authentication webpage as a factor of authentication. In various embodiments, the security token is encrypted in order to further protect against misuse.

The code of the authentication webpage may include instructions for accessing the database in order to retrieve the security token of the connected node representing the security token, thereby allowing such code to cause a system to provide the security token (e.g., to a service requiring authentication) in order to demonstrate a factor of authentication. To this end, in various embodiments, the authentication webpage may be encoded into one or more portions of code, and the portions of code may be stored in the database. In a further embodiment, the portions of code for the authentication webpage may be stored in the respective authentication webpage node 206. The portions of code may further include the security token of the authentication webpage such that the authentication webpage includes the security token and can therefore be utilized to attest to the user's identity.

In an embodiment, the security token may be stored in the encoded authentication webpage. Accordingly, the authentication webpage represented by the authentication webpage node 206 is a unique form of identification for the user such that accessing the authentication webpage can be utilized to demonstrate a factor of authentication for the user as described herein.

In another embodiment, the security token may be represented by a node in a database and connected to a node representing the authentication webpage, thereby associating the security token with the authentication webpage. In a further embodiment, the security token may be stored in the node representing the security token. To this end, in such embodiments, the code for accessing the database may include code for accessing a security token node connected to the authentication webpage node in order to retrieve the security token.

In some implementations and as depicted in FIG. 2, the authentication webpage node 206 may be connected to a UAT node 201 such that the authentication webpage node 206 effectively represents a wallet holding the UAT represented by the UAT node 201. The authentication webpage node 206 may further be connected to one or more currency nodes such as the cryptocurrency node 207, thereby further representing that the wallet holds the currency or currencies represented by such currency nodes. To this end, the authentication webpage node 206 may store data indicating ownership of the UAT represented by the UAT node 201 such that the connection between the authentication webpage node 206 and the UAT node 201 can be utilized to confirm ownership of the UAT by the owner of the wallet. Alternatively, the authentication webpage node 206 may be connected to a separate wallet node (not shown). The authentication webpage node 206 may also optionally represent a wallet program or device (e.g., the wallet 125, FIG. 1).

When the authentication webpage node 206 acts as or is connected to a wallet node, such a node may be connected to one or more cryptocurrency (Cry) nodes 207, a wallet administrator (Adm) node 208, or both. The cryptocurrency nodes 207 may represent cryptocurrency owned by the owner of the wallet. Such cryptocurrency may be used to conduct transactions involving transfers of UATs such as using the cryptocurrency to purchase a UAT to be transferred to the wallet or receiving cryptocurrency as payment for such a UAT. The wallet administrator node 208 may be associated with an administrator of the wallet (e.g., the owner of the wallet or a third party entity who has been granted the right to act on behalf of the wallet owner), and may store data indicating policies related to use of the wallet.

The UAT node 201 represents a tokenized version of a unique asset (not shown) such as, but not limited to, a non-fungible token (NFT) or a provenance and documentation token (PDT). The unique asset may be a digital or physical asset that is media content included in a webpage or is otherwise represented by media content included in the webpage such that the webpage can be encoded into portions of code (e.g., code in hypertext markup language) for projecting the media content. An NFT is a non-interchangeable token representing a digital item (i.e., a data item). A PDT is a non-interchangeable token representing a physical item. These tokens are non-interchangeable at least in that any given NFT or PDT is not necessarily equivalent to any other token of the same type, in other words, at least some NFTs represent different underlying digital items as compared to at least some other NFTs and likewise for PDTs. It should be noted that some UATs may be equivalent to each other without departing from the scope of the disclosed embodiments. As a non-limiting example, some UATs may be NFTs representing music tracks where some of those NFTs may represent the same music track and others may represent different music tracks, or each NFT may represent a distinct music track.

In some embodiments, the UAT node 201 may further include transaction data indicating historical transactions involving the UAT represented by the UAT node 201 (e.g., transactions which resulted in modification of the database involving changing connections between the UAT node 201 and wallet nodes or owning entity nodes), the initial creation of the UAT node 201, both, and the like. Consequently, the UAT node 201 may also include a complete history of ownership of the UAT. Storing such historical data allows the UAT node 201 to serve as a proof of authenticity or otherwise as a proof of ownership history for the UAT represented by the UAT node 201.

The UAT node 201 is connected to a UAT webpage (UW) node 202 representing a corresponding webpage of a UAT, where the webpage is tokenized via the hypergraph so as to mint a UAT. In various embodiments, the UAT node 201 includes one or more portions of code created by encoding the corresponding webpage represented by the UAT webpage node 202 connected to the UAT node 201. Such portions of code may include instructions in formats such as, but not limited to, cascading style sheets (CSS), Javascript, hypertext markup language (HTML), combinations thereof, and the like. In other embodiments (not shown), such portions of code may be stored in code nodes (not shown) which are distinct from the UAT node 201 and are connected to the UAT node 201, the UAT webpage node 202, or both. Such portions of code can be provided to an authorized device, thereby allowing such an authorized device to use the portions of code to generate a view of the webpage including any applicable media content.

In some embodiments, the UAT webpage node 202 may further be connected to multiple section nodes such as section (Sec) nodes 203-1 through 203-3. The section nodes 203-1 through 203-3 represent different sections of the webpage represented by the connected UAT webpage node 202. By representing sections of webpages as distinct nodes, webpage tokenization may be realized in a more granular fashion, i.e., such that multiple tokens may be created for a single webpage and multiple owning entities may each effectively own a different portion of the same webpage. The portion of a webpage for a respective owning entity may be represented and rendered as a distinct webpage including the corresponding content owned by that entity.

The UAT webpage node 202 may further be connected to a website (WS) node 204 representing the website including the webpage represented by the UAT webpage node 202. The website node 204 may further be connected to other webpage nodes (not shown) representing various webpages of the website. Additionally, the website node 204 may be connected to a location node such as a uniform resource locator (URL) node 205 representing a URL associated with the webpage. In other embodiments (not shown), each webpage node may also be connected to a corresponding URL node indicating the location of the respective webpage on the Internet.

The UAT node 201 may further be connected to one or more nodes representing policies to be applied in relation to creation, use, or access of UAT nodes such as, but not limited to, a transfer node 209, a terms of service (ToS) node 211, a usage policy (UP) node 212, or a combination thereof.

The transfer node 209 may act as a minting contract, i.e., a smart contract defining policies for creation of UAT nodes for webpages (i.e., minting of webpages as UATs). To this end, the transfer node 209 may store code that, when executed, applies the rules of the policy to the creation of UAT nodes such as the UAT node 201. Such policies may include, but are not limited to, restrictions on the number of UATs which can be created (i.e., the number of UAT nodes which can be created) for a given webpage or portion thereof. As a non-limiting example, such a policy may limit the creation of NFTs for a given webpage to 100 NFTs total.

In some implementations, the transfer node 209 may further be connected to a provider (Pro) node 210 representing a provider of the UAT. Such a provider may be, but is not limited to, a creator of the UAT, a company representing the creator of the UAT, and the like. In this regard, the provider node 210 may serve as evidence of the originator of the UAT node 201.

The terms of service node 211 includes code that, when executed, applies the rules of one or more policies defining terms of service for a UAT. Such policies may require, for example, that a user to whom the UAT is transferred (e.g., a user of a wallet represented by a wallet node to which the UAT node will be connected) agree to terms of service before being granted ownership of or access to the UAT.

The usage policy node 212 includes code that, when executed, applies the rules of one or more policies defining restrictions on use of a UAT, access to the UAT, both, and the like. Such restrictions may include, but are not limited to, requiring that UATs not be shared for free, limiting the number of uses of a given UAT, and the like. In various embodiments, multiple usage policies (which may be represented by multiple usage policy nodes, not shown), may be applied to any given UAT or series of UATs. The usage policies may be defined by a platform for the UATs, a marketplace for the UATs, a provider of a UAT, or a combination thereof, depending on the implementation.

In a further embodiment, the usage policy represented by the usage policy node 212 may require an access code before using or accessing the UAT of the connected UAT node 201 in order to prevent unauthorized access. To this end, the UAT node 201 may also be connected to an access code (AC) node 213 representing an access code required to use or access the UAT. As a non-limiting example, before web content of the webpage represented by the webpage node 202 is provided, a user of the wallet represented by the wallet node 206 or other user indicated by the wallet node 206 may be required to enter the access code indicated by the access code node 213.

It should be noted that the disclosed embodiments are not limited to the implementation in which the authentication webpage represented by the authentication webpage node 206 also acts as a wallet demonstrating ownership of UATs illustrated in FIG. 2, and that various disclosed embodiments may utilize the authentication webpage as a factor of authentication regardless of whether the authentication webpage is represented by an authentication webpage node connected to a UAT node or otherwise utilized in connection with UAT ownership.

It should also be noted that FIG. 2 depicts various specific numbers of nodes, numbers of connections, types of nodes, and connections between different types of nodes for example purposes, but that the disclosed embodiments are not necessarily limited to the specific depiction of nodes and connections illustrated in FIG. 2. In particular, only one instance of many types of nodes are depicted in FIG. 2 for simplicity purposes, but in various implementations multiple of each node may be included without departing from the scope of the disclosure.

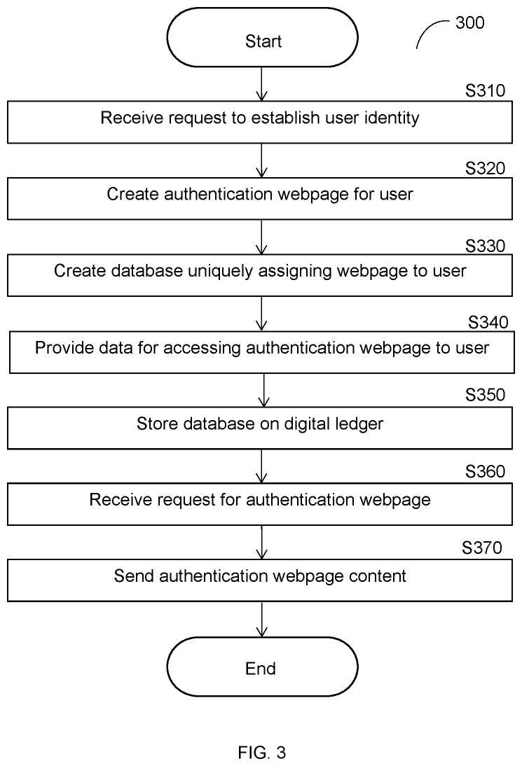

FIG. 3 is a flowchart illustrating a method for authenticating users via uniquely assigned webpages according to an embodiment. In an embodiment, the method is performed by the authentication establisher 130.

At S310, a request to establish a user identity is received. The request may include, but is not limited to, information about the user, an indicator of a preferred channel of communication for one or more additional factors of authentication, information used to send messages via other communication channels (e.g., an email address, a phone number, etc.), a combination thereof, and the like.

Once the user identity is established via creation and unique assignment of an authentication webpage as described herein, the authentication webpage can act as an attestation of the user's identity by virtue of the user having access to their respective uniquely associated authentication webpage. More specifically, the user is uniquely assigned a security token accessible via an authentication webpage such that the authentication webpage is unique to that user. A web address such as a uniform resource locator (URL) or other identifier used to access the authentication webpage may be secretly provided to the user such that only the user has access to the authentication webpage. Consequently, accessing the authentication webpage (which only the user should have access to) can demonstrate a factor of authentication.

At S320, an authentication webpage is created for the user. The authentication webpage is created such that it includes a security token (e.g., an encrypted code that is only included in the authentication webpage of that user and is not used for other users) or includes instructions for accessing a security token (e.g., accessing a security token stored in the database 145, FIG. 1). The authentication webpage may further be created such that a display of the authentication webpage (e.g. on a device used by the user) includes a link or other interactable icon that, when interacted with, triggers sending the security token to a service requiring authentication, either directly (i.e., directly sending the security token to the service) or indirectly (e.g., by sending a message including the security token via a channel of communication selected by the user as part of a two-factor authentication process).

When such an icon is used for indirectly sending the security token, the authentication webpage may trigger a message sent via a communication channel selected by the user. Such a message may be utilized to demonstrate an additional factor of authentication, i.e., since receipt of the message demonstrates that the user knows or is in possession of the account or device to which the message is sent. The message may include the security token to be used as proof for the first factor of authentication (i.e., accessing the authentication webpage). The preferred communication channel may be pre-designated by the user (e.g., as received in a request to establish a user identity), or may be selected by the user when the user interacts with the authentication webpage. As a non-limiting example, the authentication webpage may include multiple icons, with each icon triggering sending of a message via a respective channel (e.g., email, text message, short message service, etc.) such that the user can select their preferred channel of communication by clicking on one of the icons.

In an embodiment, S320 includes encoding the authentication webpage into code. This code includes instructions that, when executed by a system (for example, at the user device 120, FIG. 1), configure the device to display the authentication webpage including any links or other interactable icons and to directly or indirectly provide the respective security token to a service requiring authentication.

At S330, a database is created based on the authentication webpage. Creating the database may include creating a new database or adding to an existing database.

In an embodiment, the created database includes nodes, and the code of the authentication webpage is distributed among at least some of the nodes of the database. In an embodiment, the database at least includes authentication webpage nodes representing authentication webpages assigned to respective users. Each authentication webpage node is associated with a respective authentication webpage and indicates at least a portion of the respective webpage that is represented by the node. In a further embodiment, the code of each authentication webpage is stored in its respective authentication webpage node.

In some implementations, the database may further include other types of nodes including, but not limited to, unique asset token (UAT) nodes, currency nodes, administrator nodes, wallet nodes combinations thereof, and the like. Various types of nodes are depicted in and described with respect to FIG. 2 as discussed above.

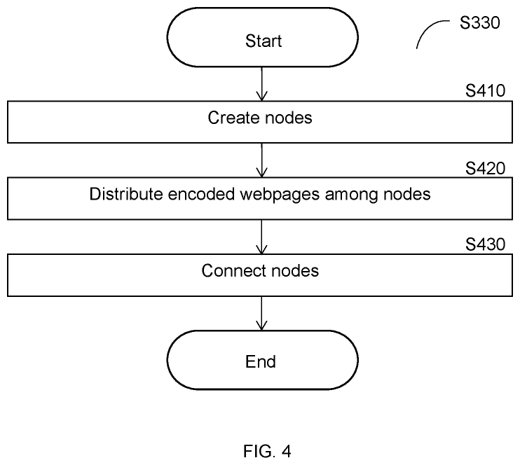

In an embodiment, the database may be created as discussed with respect to FIG. 4. FIG. 4 is a flowchart S330 illustrating a method for creating a database uniquely assigning webpages to users according to an embodiment.

At S410, nodes of the database are created. In an embodiment, the nodes in the database at least include authentication webpage nodes representing encoded authentication webpages or portions thereof.

At S420, the code of encoded webpages represented in the database are distributed among the created nodes. In an embodiment, the portions of code may be distributed into webpage nodes of the respective webpages which were encoded into that code. In particular, code of authentication webpages may be distributed in their respective authentication webpage nodes, code for displaying content associated with unique assets may be distributed in UAT nodes, both, and the like.

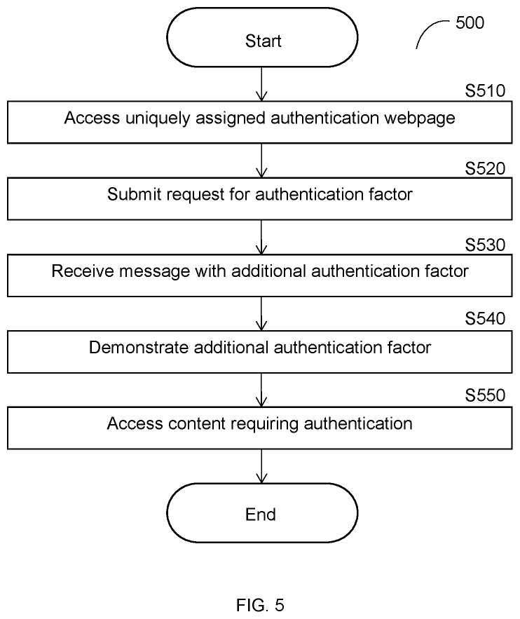

In an embodiment, the code distributed in the database further includes a respective security token for each authentication webpage represented in the database. As noted above, each security token is uniquely assigned to a respective user such that the authentication webpage associated with a given security token is also uniquely assigned to the respective user. The security token may, in turn, be provided in messages sent as part of an authentication process (for example, an authentication process described below with respect to FIG. 5) in order to ensure that the demonstration of authentication factors is performed securely. In another embodiment, the code includes instructions for causing a system to access the security token, for example, in the database. Thus, when the code of the authentication webpage stored in the database is provided to a user device, the user device becomes configured to display the authentication webpage and to provide the respective security token.

At optional S430, the created nodes may be connected. In an embodiment, each authentication webpage node may be connected to one or more nodes related to assets owned by the user to which the authentication webpage node is assigned, thereby allowing the authentication webpage to further act as a wallet associated with data indicating ownership of such assets. To this end, each authentication webpage node may be connected in the database to one or more UAT nodes, a currency node, a combination thereof, and the like. Alternatively, each authentication webpage node may be connected to a respective wallet node where each wallet node is configured to one or more other nodes representing assets held by the wallet represented by the wallet node.

Returning to FIG. 3, at S340, data used to access an authentication webpage is provided to the user to which the authentication webpage is uniquely assigned. The data indicates a web address of the authentication webpage or otherwise can be used to navigate to the authentication webpage and may include, but is not limited to, a pointer to a location of the user's authentication webpage (e.g., in the form of a hyperlink pointing to a web address to the authentication webpage), and may be sent, for example, to an account associated with the user (e.g., an email containing the hyperlink may be sent to the user's email address). Alternatively or collectively, this data may be provided to a device owned by the user (e.g., a wallet device or other physical device designated for the purpose of providing an ownership authentication factor for the user).

At optional S350, the database is stored on a digital ledger. In an embodiment, S350 may include uploading the database to a decentralized digital ledger such as a blockchain. As noted above, storing the database on a blockchain allows for ensuring the accuracy of the data in the database by providing an immutable record against which the database can be compared when making transfers, and storing the database on a decentralized ledger in addition to a centralized ledger allows for portability, i.e., the database may be transferred to a new digital ledger relatively easily. As a non-limiting example, the database may be stored as a side chain on a blockchain.

At S360, a request for the authentication webpage is received. The request may be received, for example, via a user clicking a hyperlink to the authentication webpage, entering a URL of the authentication into a browser program, or otherwise navigating to the authentication webpage via their user device.

At S370, in response to the request for the authentication webpage, content of the authentication webpage is sent to the user, for example, by sending the code of the authentication webpage for execution on a user device from which the request was sent. When the code of the encoded authentication webpage is executed on the user device, the user device becomes configured to display content of the authentication webpage and to perform authentication-related actions such as, but not limited to, sending the respective security token to a service requiring authentication, sending the respective security token to the requesting user device, navigating the user to a destination webpage, sending a message including the security token to be used as an additional factor of authentication via a communication channel selected by the user, combinations thereof, and the like.

Accessing the authentication webpage sent to the user device serves as a factor of authentication, and the webpage may be used to facilitate the authentication process by triggering sending a message that serves as an additional factor of authentication and which can automatically navigate the user to a destination (e.g., a webpage that the user wishes to access for which authentication of the user is needed prior to such access or a feature of such a webpage). In this regard, the authentication webpage may behave like an authenticator application that demonstrates an ownership or knowledge authentication factor.

FIG. 5 is an example flowchart 500 illustrating an example authentication by a user via a uniquely assigned webpage.

At S510, an authentication webpage that is uniquely assigned to the user is accessed by the user (e.g., via a user device operated by the user). This access may be performed when, for example, the user attempts to access a service that requires authentication such as, but not limited to, a payment service, a service related to a user account of the user, and the like. The access may occur via the user navigating, via their user device, to a location of the authentication webpage, which results in the user device sending a request for the authentication webpage. As a non-limiting example, the user may navigate to a URL of the authentication via a browser installed on their user device, which in turn results in the user device sending a request to a server for content of the authentication webpage.

In some embodiments, the uniquely assigned authentication webpage of the user may be accessed via another webpage, program, or device associated with the user. As a non-limiting example, a wallet webpage associated with the user may include a link to the authentication webpage, and the user may access the authentication webpage by clicking on the link to the authentication webpage on their wallet webpage. As another non-limiting example, a wallet program installed on the user device (e.g., the wallet 125, FIG. 1) may cause display of a virtual wallet including a link to the authentication webpage, and the user may access the authentication webpage by interacting with that link.

At S520, a request to provide an authentication factor in relation to the authentication webpage is submitted. The request may be submitted by, for example, the user interacting with an icon on the authentication webpage while the authentication webpage is displayed on the user device, thereby requesting the authentication factor.

In some implementations, the request sent at S520 depends on which icon is interacted with on the authentication webpage. More specifically, in some implementations, the authentication webpage may require an additional factor of authentication in addition to accessing the authentication webpage such that any request for a factor of authentication from the authentication webpage further requires the user to demonstrate a second factor of authentication. As a non-limiting example, a first icon may represent a request to send a message via email, and a second icon may represent a request to send a message via short message service (SMS). A user interacting with the first icon will trigger sending such an email message, and a user interacting with the second icon will trigger sending such an SMS message.

At optional S530, a message with an additional authentication factor is received by the user via a communication channel selected by the user (e.g., a previously designated preferred communication channel or a communication channel selected via interaction with a particular icon as discussed above). The message may include a link to a destination webpage or may include code that, when executed by the device at which the message is received, causes the device to navigate to a next location (e.g., a destination webpage that requires authentication using a multi-factor authentication process). The device, account, program, or other location to which the additional authentication factor message should be sent may be predefined, for example, when an identity of the user is initially established or otherwise when the user designates preferred channels of communication.

In this regard, it is noted that accessing the authentication webpage serves as one form of authentication, and interacting with a message received via a selected communication channel may therefore serve as an additional form of authentication, thereby providing a multi-factor authentication process using a uniquely assigned webpage as one factor of authentication. In various implementations where the uniquely assigned authentication webpage acts as a wallet program (i.e., by providing services related to ownership of assets such as accessing those assets or engaging in transactions involving those assets) or is otherwise associated with a wallet program or device of the user, the disclosed embodiments therefore enable utilizing such a wallet to demonstrate a factor of authentication.

It is further noted that some existing solutions for authenticating via webpages may require the user to enter credentials (e.g., a username or password) via a webpage as part of a knowledge authentication factor. However, the disclosed embodiments allow for utilizing the webpage itself as an authentication factor (e.g., an ownership factor demonstrated via showing ownership of the authentication webpage by the user). This may allow, among other things, authenticating without requiring a password, i.e., a passwordless authentication process and, moreover, a passwordless multi-factor authentication process. In other words, by virtue of the user having access to the authentication webpage (e.g., by knowing the web address of the authentication webpage or being in possession of a device or program having access to the authentication webpage), the user provides evidence of their identity.

At optional S540, the user demonstrates the additional authentication factor. In an example implementation, S540 includes interacting with the received message (e.g., by clicking on an icon or link in the received message). This interaction demonstrates that the user is in possession of the device, program, or account used for the additional authentication factor, thereby authenticating the user.

At S550, content requiring authentication (i.e., the content for which the authentication webpage was originally accessed) is accessed. In an example implementation, the content may be accessible via a destination webpage, and S550 may include navigating to the destination webpage in order to access the content. Further, S550 may include interacting with a link to the destination webpage (e.g., a link included in the authentication webpage or in the received message).

As a non-limiting example, when the user attempts to make a purchase via a store webpage, the webpage may require accessing a wallet owned by the user or otherwise verifying the user's identity before allowing the user to navigate to a payment webpage to complete the transaction. In order to authenticate and demonstrate their identity, the user navigates to their authentication webpage by inputting the URL of their authentication into a browser executed on their tablet computer. The authentication webpage is displayed on the tablet computer. The displayed authentication webpage includes icons for sending two-factor authentication (2FA) messages via different channels including via email, text message, and SMS message. The user clicks on the icon for text message, thereby submitting a request for a second authentication factor in the form of a text message including a link to the payment webpage to the user's smartphone. A text message including this link is received by the user via their smartphone. By clicking on this link via the user's smartphone, the smartphone is navigated to the payment webpage, thereby authenticating the user, accessing the content of the payment webpage, and allowing the user to complete the transaction.

It should be noted that FIG. 5 depicts a two-factor authentication (2FA) process merely for example purposes, and that other numbers of factors of authentication may be equally utilized without departing from at least some disclosed embodiments. In some embodiments, accessing the uniquely assigned webpage may serve as a single factor of authentication. In other embodiments, three or more factors of authentication may be utilized.

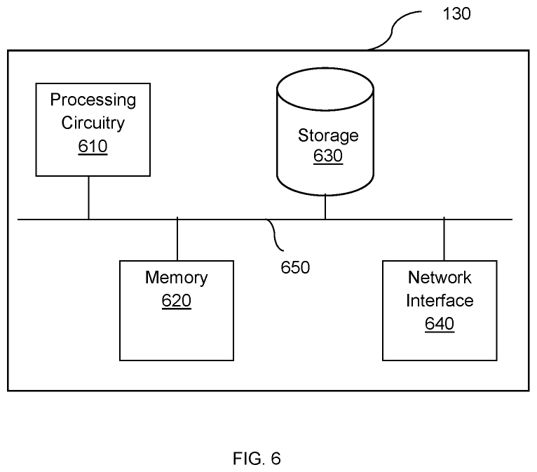

FIG. 6 is an example schematic diagram of an authentication establisher 130 according to an embodiment. The authentication establisher 130 includes a processing circuitry 610 coupled to a memory 620, a storage 630, and a network interface 640. In an embodiment, the components of the authentication establisher 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the authentication establisher 130 to communicate with, for example, the user device 120, the data storage 140, the web content sources 150, the blockchain network 160, combinations thereof, and the like.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for authenticating via uniquely assigned webpages, comprising:
encoding an authentication webpage into code, wherein the code of the authentication webpage at least configures a system to display the authentication webpage and to provide a security token to a service requiring authentication when the code is executed by the system, wherein the authentication webpage has a web address, wherein the security token is uniquely assigned to a user;
creating a database including the code of the authentication webpage; and
providing the code of the authentication webpage from the database to a device when the device navigates to the web address of the authentication webpage.

2. The method of claim 1, wherein the security token is provided to demonstrate a first factor of authentication by the user, wherein the code of the authentication webpage further configures the system to cause a message to be sent in order to demonstrate a second factor of authentication by the user when the code of the authentication webpage is executed by the system.

3. The method of claim 2, wherein the message includes the security token.

4. The method of claim 2, wherein the message is sent in response to an interaction of the user with the authentication webpage.

5. The method of claim 4, wherein the authentication webpage includes a plurality of icons, each icon representing a respective communication channel to be used for sending the message, wherein the interaction of the user with the authentication webpage includes interacting with a first icon of the plurality of icons, wherein the message is sent via the respective communication channel of the first icon.

6. The method of claim 1, wherein the authentication webpage is further associated with a wallet of the user, wherein the wallet is any of a wallet computer program and a wallet computing device.

7. The method of claim 6, wherein the database includes a wallet node representing the wallet and at least one asset node representing at least one asset accessible via the wallet, wherein the wallet node is connected to each of the at least one asset node.

8. The method of claim 7, wherein the at least one asset node includes at least one of: at least one unique asset token node, and at least one cryptocurrency node.

9. The method of claim 7, wherein the code of the authentication webpage is stored in the wallet node.

10. A non-transitory computer readable medium having stored thereon instructions for causing a processing circuitry to execute a process, the process comprising:
encoding an authentication webpage into code, wherein the code of the authentication webpage at least configures a system to display the authentication webpage and to provide a security token to a service requiring authentication when the code is executed by the system, wherein the authentication webpage has a web address, wherein the security token is uniquely assigned to a user;
creating a database including the code of the authentication webpage; and
providing the code of the authentication webpage from the database to a device when the device navigates to the web address of the authentication webpage.

11. A system for authenticating via uniquely assigned webpages, comprising:
a processing circuitry; and
a memory, the memory containing instructions that, when executed by the processing circuitry, configure the system to:
encode an authentication webpage into code, wherein the code of the authentication webpage at least configures a system to display the authentication webpage and to provide a security token to a service requiring authentication when the code is executed by the system, wherein the authentication webpage has a web address, wherein the security token is uniquely assigned to a user;
create a database including the code of the authentication webpage; and
provide the code of the authentication webpage from the database to a device when the device navigates to the web address of the authentication webpage.

12. The system of claim 11, wherein the security token is provided to demonstrate a first factor of authentication by the user, wherein the code of the authentication webpage further configures the system to cause a message to be sent in order to demonstrate a second factor of authentication by the user when the code of the authentication webpage is executed by the system.

13. The system of claim 12, wherein the message includes the security token.

14. The system of claim 12, wherein the message is sent in response to an interaction of the user with the authentication webpage.

15. The system of claim 14, wherein the authentication webpage includes a plurality of icons, each icon representing a respective communication channel to be used for sending the message, wherein the interaction of the user with the authentication webpage includes interacting with a first icon of the plurality of icons, wherein the message is sent via the respective communication channel of the first icon.

16. The system of claim 11, wherein the authentication webpage is further associated with a wallet of the user, wherein the wallet is any of a wallet computer program and a wallet computing device.

17. The system of claim 16, wherein the database includes a wallet node representing the wallet and at least one asset node representing at least one asset accessible via the wallet, wherein the wallet node is connected to each of the at least one asset node.

18. The system of claim 17, wherein the at least one asset node includes at least one of: at least one unique asset token node, and at least one cryptocurrency node.

19. The system of claim 17, wherein the code of the authentication webpage is stored in the wallet node.
